(19) United States
(12) Patent Application Publication
(10) Pub. No.: US 2026/0362156 A1
(43) Pub. Date: Nov. 12, 2026

(54) MACHINE LEARNING ASSISTED COVERAGE PLANNING FOR A WIRELESS COMMUNICATIONS SYSTEM (WCS)

(71) Applicant: IBWAVE SOLUTIONS INC., Mount Royal (CA)

(72) Inventors: Ali Jemmali, Gatineau (CA); Vladan Jevremovic, Houston, TX (US); Konstantinos Sarris, North York (CA); Aristeidis Seretis, Montreal (CA)

(21) Appl. No.: 19/725,557

(22) Filed: Jun. 30, 2026

Related U.S. Application Data
(63) Continuation of application No. PCT/US2024/060637, filed on Dec. 18, 2024.
(60) Provisional application No. 63/617,528, filed on Jan. 4, 2024.

(51) Int. Cl. H04W 16/18; H04L 41/16; H04W 4/021

(52) U.S. Cl. CPC H04W 16/18; H04L 41/16; H04W 4/021

(57) ABSTRACT

Machine learning assisted coverage planning determination for a wireless communications system (WCS) is provided. The WCS includes multiple wireless transmitters configured to provide wireless communication services to a vast number of wireless receivers in a large venue. To ensure that the wireless transmitters can collectively provide a desirable coverage in the large venue, it is often necessary to compute a coverage map for each RF channel associated with each of the wireless transmitters. Herein, a computing device is configured to train a machine learning network based on a smaller sample set of the wireless transmitters and then use the trained machine learning network to regenerate the coverage map involving all the wireless transmitters when any configuration change is made in the WCS. As such it is possible to dramatically reduce processing time and computational resources required for reconfiguring the WCS, thus helping to reduce unwanted service disruption in the WCS.

### CROSS-REFERENCE TO RELATED APPLICATION

This application is a continuation of International Patent Application No. PCT/US2024/060637, filed on Dec. 18, 2024, which claims the benefit of priority of U.S. Provisional Application No. 63/617,528, filed on Jan. 4, 2024, the content of which is relied upon and incorporated herein by reference in its entirety.

### BACKGROUND

The disclosure relates generally to using machine learning to help determine a radio frequency (RF) coverage plan for a wireless communications system (WCS), which can include a fifth generation (5G) system, a 5G new-radio (5G-NR) system, and/or a distributed communications system (DCS).

Wireless communication is rapidly growing, with ever-increasing demands for high-speed mobile data communication. As an example, local area wireless services (e.g., so-called “Wi-Fi” systems) and wide area wireless services are being deployed in many different types of areas (e.g., coffee shops, airports, libraries, etc.). Communications systems have been provided to transmit and/or distribute communications signals to wireless nodes called “clients,” “client devices,” or “wireless client devices,” which must reside within the wireless range or “cell coverage area” in order to communicate with an access point device. Example applications where communications systems can be used to provide or enhance coverage for wireless services include public safety, cellular telephony, wireless local access networks (LANs), location tracking, and medical telemetry inside buildings and over campuses. One approach to deploying a communications system involves the use of radio nodes/base stations that transmit communications signals distributed over physical communications medium remote units forming RF antenna coverage areas, also referred to as “antenna coverage areas.” The remote units each contain or are configured to couple to one or more antennas configured to support the desired frequency(ies) of the radio nodes to provide the antenna coverage areas. Antenna coverage areas can have a radius in a range from a few meters up to twenty meters, as an example. Another example of a communications system includes radio nodes, such as base stations, that form cell radio access networks, wherein the radio nodes are configured to transmit communications signals wirelessly directly to client devices without being distributed through intermediate remote units.

For example, FIG. 1 is an example of a WCS 100 that includes a radio node 102 configured to support one or more service providers 104(1)-104(N) as signal sources (also known as “carriers” or “service operators”—e.g., mobile network operators (MNOs)) and wireless client devices 106(1)-106(W). For example, the radio node 102 may be a base station (eNodeB) that includes modem functionality and is configured to distribute communications signal streams 108(1)-108(S) to the wireless client devices 106(1)-106(W) based on communications signals 110(1)-110(N) received from the service providers 104(1)-104(N). The communications signal streams 108(1)-108(S) of each respective service provider 104(1)-104(N) in their different spectrums are radiated through an antenna 112 to the wireless client devices 106(1)-106(W) in a communication range of the antenna 112. For example, the antenna 112 may be an antenna array. As another example, the radio node 102 in the WCS 100 in FIG. 1 can be a small cell radio access node (“small cell”) that is configured to support the multiple service providers 104(1)-104(N) by distributing the communications signal streams 108(1)-108(S) for the multiple service providers 104(1)-104(N) based on respective communications signals 110(1)-110(N) received from a respective evolved packet core (EPC) network CN₁-CN_{N} of the service providers 104(1)-104(N) through interface connections. The radio node 102 includes radio circuits 118(1)-118(N) for each service provider 104(1)-104(N) that are configured to create multiple simultaneous RF beams (“beams”) 120(1)-120(N) for the communications signal streams 108(1)-108(S) to serve multiple wireless client devices 106(1)-106(W). For example, the multiple RF beams 120(1)-120(N) may support multiple-input, multiple-output (MIMO) communications.

The radio node 102 of the WCS 100 in FIG. 1 may be configured to support service providers 104(1)-104(N) that have a different frequency spectrum and do not share the spectrum. Thus, in this instance, the communications signals 110(1)-110(N) from the different service providers 104(1)-104(N) do not interfere with each other even if transmitted by the radio node 102 at the same time. The radio node 102 may also be configured as a shared spectrum communications system where the multiple service providers 104(1)-104(N) have a shared spectrum. In this regard, the capacity supported by the radio node 102 for the shared spectrum is split (i.e., shared) between the multiple service providers 104(1)-104(N) for providing services to the subscribers.

The radio node 102 in FIG. 1 can also be coupled to a distributed communications system (DCS), such as a distributed antenna system (DAS), such that the radio circuits 118(1)-118(N) remotely distribute the communications signals 110(1)-110(N) of the multiple service providers 104(1)-104(N) to remote units. The remote units can each include an antenna array that includes tens or even hundreds of antennas for concurrently radiating the communications signals 110(1)-110(N) to subscribers using spatial multiplexing. Herein, the spatial multiplexing is a scheme that takes advantage of the differences in RF channels between transmitting and receiving antennas to provide multiple independent streams between the transmitting and receiving antennas, thus increasing throughput by sending data over parallel streams. Accordingly, the remote units can be said to radiate the communications signals 110(1)-110(N) to subscribers based on a massive multiple-input multiple-output (M-MIMO) scheme.

The WCS 100 may be configured to provide wireless communication services to tens of thousands of the wireless client devices 106(1)-106(W) (a.k.a. wireless receivers) located at a large venue (e.g., a sports stadium) using tens or even hundreds of the radio nodes 102 (a.k.a. wireless transmitters). These wireless transmitters must be provided at strategically selected locations to provide the best possible RF coverage over the large venue. Commercially available RF network design and planning tools, such as Ray Tracing and Ray Launching, are often used by RF engineers to help plan wireless network deployment, produce RF signal coverage maps, and calculate network capacity. Given that the RF beams 120(1)-120(N) radiated from each of the wireless transmitters may propagate, reflect, and/or diffract from potentially multiple objects before reaching an intended wireless receiver(s), such RF network design and planning tools need to approximate a signal propagation path between each of the wireless transmitters and each of the wireless receivers. More specifically, these computer-aided design (CAD) tools need to execute a complex algorithm that approximates the propagation paths between the wireless transmitters and the wireless receivers by connecting each of the wireless transmitters with each of the wireless receivers with one or more rays. As a result, the algorithm can take a very long time (e.g., hours, or even days) to execute given the vast number of the wireless transmitters and the wireless receivers in the very large venue. Moreover, when a configuration change (e.g., adding, removing, or relocating of wireless transmitters) is made in the large venue, the time-consuming coverage planning process must be repeated to re-approximate the propagation paths between the wireless transmitters and the wireless receivers. Hence, it is desirable to shorten the time required for the coverage planning process, especially when the configuration change is made in the large venue.

### SUMMARY

Embodiments disclosed herein include machine learning assisted coverage planning determination for a wireless communications system (WCS). In examples discussed herein, the WCS includes multiple wireless transmitters configured to provide wireless communication services to a vast number of wireless receivers in a large venue (e.g., indoor/outdoor stadium, auditorium, etc.). To ensure that the wireless transmitters can collectively provide a desirable coverage in the large venue, it is often necessary to compute a coverage map for each RF channel associated with each of the wireless transmitters. Conventional planning tools, such as Ray Tracing and Ray Launching, can take a longer processing time and/or demand a higher computational resource to execute, particularly when a configuration change is made in the large venue. In embodiments disclosed herein, a computing device is configured to train a machine learning network based on a smaller sample set of the wireless transmitters and then use the trained machine learning network to regenerate the coverage map involving all the wireless transmitters when any configuration change is made in the WCS. With assistance from the machine learning network, it is possible to dramatically reduce processing time and computational resources required for reconfiguring the WCS, thus helping to reduce unwanted service disruption in the WCS.

One exemplary embodiment of the disclosure relates to a computing device. The computing device is configured to receive a set of raw input data related to a plurality of wireless transmitters deployed in a venue wherein a WCS is deployed. The computing device is also configured to generate a training coverage map of the venue based on the set of raw input data. The computing device is also configured to determine a set of refined input data corresponding to the plurality of wireless transmitters from the set of raw input data. The computing device is also configured to sample the set of refined input data to generate a set of training data corresponding to a sample set of the plurality of wireless transmitters. The computing device is also configured to train a machine learning (ML) network based on the training coverage map and the set of training data.

An additional exemplary embodiment of the disclosure relates to a method for using ML to assist in coverage planning of a WCS. The method includes receiving a set of raw input data related to a plurality of wireless transmitters deployed in a venue wherein the WCS is deployed. The method also includes generating a training coverage map of the venue based on the set of raw input data. The method also includes determining a set of refined input data corresponding to the plurality of wireless transmitters from the set of raw input data. The method also includes sampling the set of refined input data to generate a set of training data corresponding to a sample set of the plurality of wireless transmitters. The method also includes training an ML network based on the training coverage map and the set of training data.

An additional exemplary embodiment of the disclosure relates to a WCS. The WCS includes a centralized services node coupled to a service node. The WCS also includes a plurality of wireless transmitters coupled to the centralized services node. The WCS also includes a computing device. The computing device is configured to receive a set of raw input data related to the plurality of wireless transmitters deployed in a venue wherein a WCS is deployed. The computing device is also configured to generate a training coverage map of the venue based on the set of raw input data. The computing device is also configured to determine a set of refined input data corresponding to the plurality of wireless transmitters from the set of raw input data. The computing device is also configured to sample the set of refined input data to generate a set of training data corresponding to a sample set of the plurality of wireless transmitters. The computing device is also configured to train a machine learning (ML) network based on the training coverage map and the set of training data.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of an exemplary wireless communications system (WCS), such as a distributed communications system (DCS), configured to distribute communications services to remote coverage areas;

FIGS. 2A and 2B are schematic diagrams illustrating an exemplary large venue for which machine learning assisted coverage planning can be performed according to embodiments disclosed in the present disclosure;

FIG. 3 is a schematic diagram of an exemplary WCS configured to provide wireless communication services in the large venue of FIG. 2 and a computing device that can be provided therein to carry out machine learning assisted coverage planning;

FIG. 4 is a schematic diagram providing an exemplary illustration as to how the computing device in FIG. 3 can perform machine learning assisted coverage planning for the WCS of FIG. 3;

FIGS. 5A and 5B are histograms providing an exemplary visual validation of a machine learning network training performed by the computing device of FIG. 4 for assisting in the coverage planning of the WCS of FIG. 3;

FIG. 6 is a flowchart of an exemplary process that can be employed by the computing device in FIG. 4 for using machine learning to assist in coverage planning for the WCS of FIG. 3;

FIG. 7 is a schematic diagram providing an exemplary illustration of the computing device in FIGS. 3 and 4 configured according to an embodiment of the present disclosure;

FIG. 8 is a partial schematic cut-away diagram of an exemplary building infrastructure in a WCS, such as the WCS of FIG. 3 that includes the computing device of FIG. 5 to perform machine learning assisted coverage planning;

FIG. 9 is a schematic diagram of an exemplary mobile telecommunications environment that can includes the WCS of FIG. 3 that includes the computing device of FIG. 5 to perform machine learning assisted coverage planning; and

FIG. 10 is a schematic diagram of a representation of an exemplary computer system that can be included in or interfaced with any of the components in the WCS of FIG. 3 and the computing device in FIG. 5 to perform machine learning assisted coverage planning, wherein the exemplary computer system is configured to execute instructions from an exemplary computer-readable medium.

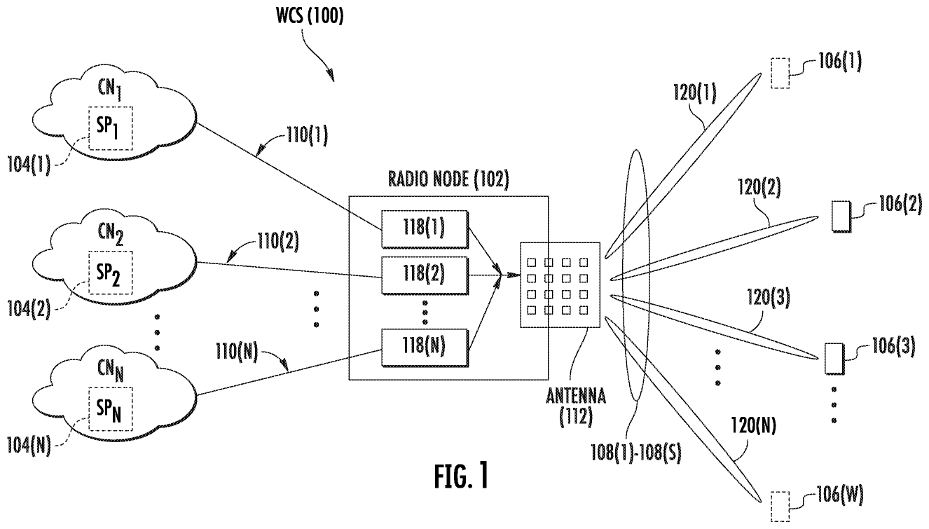

### DETAILED DESCRIPTION

Embodiments disclosed herein include machine learning assisted coverage planning determination for a wireless communications system (WCS). In examples discussed herein, the WCS includes multiple wireless transmitters configured to provide wireless communication services to a vast number of wireless receivers in a large venue (e.g., indoor/outdoor stadium, auditorium, etc.). To ensure that the wireless transmitters can collectively provide a desirable coverage in the large venue, it is often necessary to compute a coverage map for each RF channel associated with each of the wireless transmitters. Conventional planning tools, such as Ray Tracing and Ray Launching, can take a longer processing time and/or demand a higher computational resource to execute, particularly when a configuration change is made in the large venue. In embodiments disclosed herein, a computing device is configured to train a machine learning network based on a smaller sample set of the wireless transmitters and then use the trained machine learning network to regenerate the coverage map involving all the wireless transmitters when any configuration change is made in the WCS. With assistance from the machine learning network, it is possible to dramatically reduce processing time and computational resources required for reconfiguring the WCS, thus helping to reduce unwanted service disruption in the WCS.

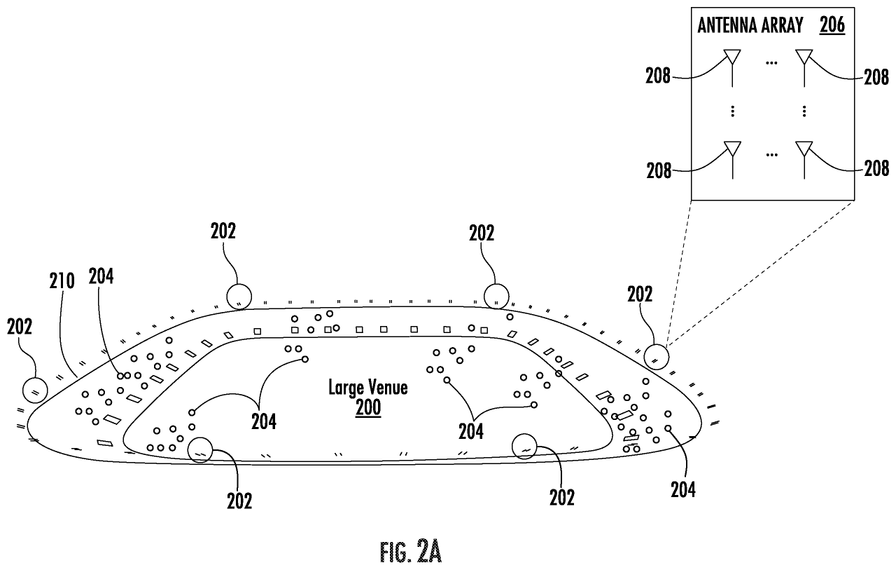

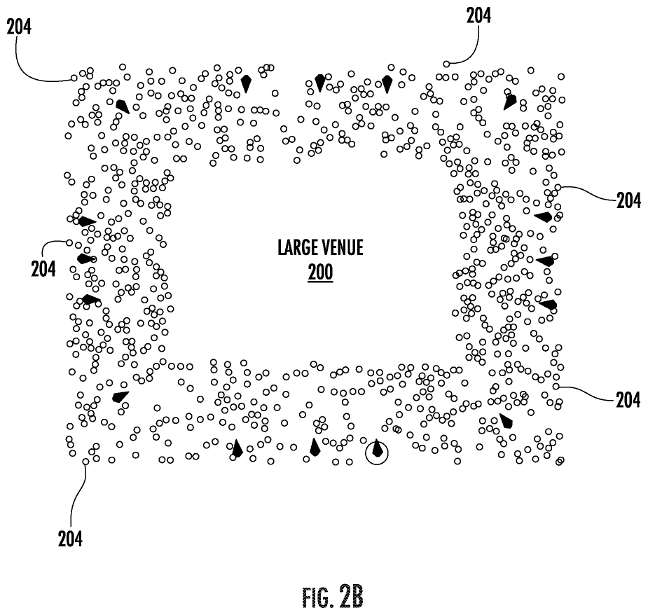

FIG. 2A is a schematic diagram of an exemplary large venue 200 for which machine learning assisted coverage planning can be performed according to embodiments disclosed in the present disclosure. In a non-limiting example, the large venue 200 can be a sports stadium wherein a plurality of wireless transmitters 202 (e.g., tens or even hundreds) can be provided at strategically selected locations to provide wireless communication services to a vast number (e.g., thousands) of wireless receivers 204 in the large venue 200. Herein, each of the wireless transmitters 202 can include a respective antenna array 206 that further includes multiple antenna elements 208. Specifically, the antenna array 206 in each of the wireless transmitters 202 is configured to radiate a directional main lobe with narrow half power beamwidth and the side lobes should have a variable power level. Notably, the antenna array 206 in each of the wireless transmitters 202 is not configured to radiate in a symmetric pattern.

In a non-limiting example, the large venue 200 has a symmetrical geometrical shape (e.g., rectangular shaped, octagonal shaped, etc.) and the wireless transmitters 202 are mounted on a top level 210 to provide line-of-sight beamforming coverage for all the wireless receivers 204. As shown in FIG. 2A, the wireless receivers 204 may be located at any location in the large venue 200. Moreover, the wireless receivers 204 may be highly populated in some locations in the large venue 200, but rather scattered in other locations in the large venue 200. For the purpose of coverage planning, it is assumed that the wireless receivers 204 are distributed in the large venue 200 according to a uniform distribution. FIG. 2B is a schematic diagram illustrating such uniform distribution of the wireless receivers 204 in the large venue 200.

As an example, in a sports stadium, the wireless receivers 204 can be uniformly placed at the seating levels. To account for height variation (e.g., a standing wireless user vs. a seated wireless user) among the wireless receivers 204, a random variable may be added to a respective height of each of the wireless receivers 204. In an embodiment, the random variable may conform to a normal distribution, with a mean value of one-half (½) meter and a standard deviation of one meter. For the purpose of reference, the wireless receivers 204 are referred interchangeably as 204₁-204_{N}, wherein N represents a total number of the wireless receivers 204 placed in the large venue 200 according to the uniform distribution.

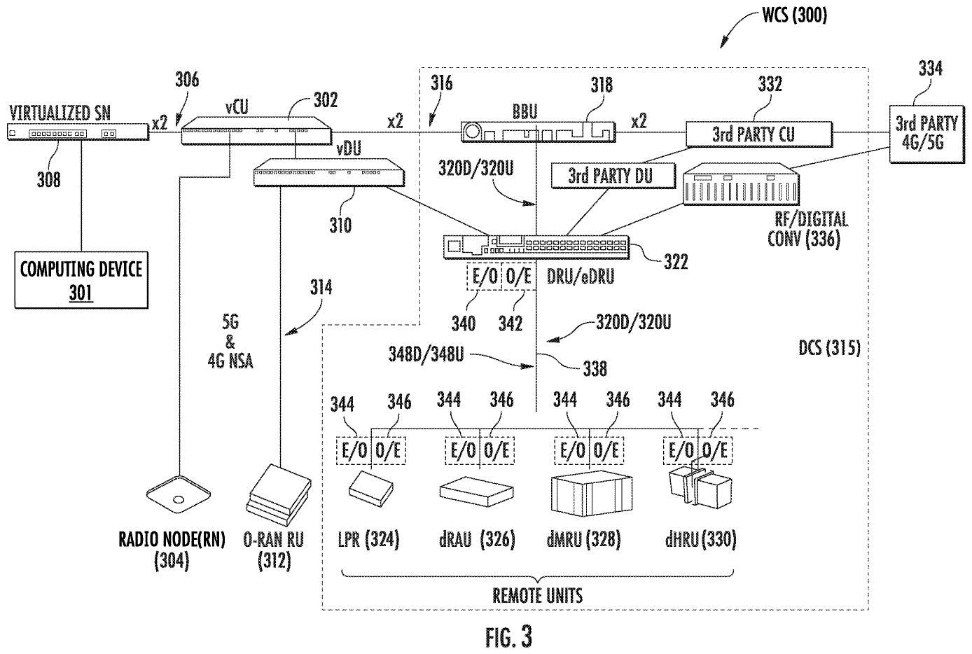

In an embodiment, a WCS can be deployed at the large venue 200 to provide various wireless communication services, such as fourth generation (4G), fifth generation (5G), 5G new-radio (5G-NR), Wi-Fi, and/or distributed communication system (DCS) services. In this regard, FIG. 3 is a schematic diagram of an exemplary WCS 300 configured to provide wireless communication services in the large venue 200 of FIG. 2 and a computing device 301 can be provided therein to carry out machine learning assisted coverage planning in accordance with embodiments of the present disclosure. In a non-limiting example, the computing device 301 can be a personal computer (e.g., laptop or desktop), a cloud-based computer server, and so on.

The WCS 300 supports both legacy 4G LTE, 4G/5G non-standalone (NSA), and 5G standalone communications systems. As shown in FIG. 3, a centralized services node 302 is provided and is configured to interface with a core network to exchange communications data and distribute the communications data as radio signals to various wireless nodes. In this example, the centralized services node 302 is configured to support distributed communications services to a radio node 304 (e.g., 5G or 5G-NR gNB). Despite the fact that only one radio node 304 is shown in FIG. 3, it should be appreciated that the WCS 300 can be configured to include additional numbers of the radio node 304, as needed. In one embodiment, the computing device 301 may be provided as part of the centralized services node 302.

The functions of the centralized services node 302 can be virtualized through, for example, an x2 interface 306 to another services node 308. The centralized services node 302 can also include one or more internal radio nodes that are configured to be interfaced with a distribution unit (DU) 310 to distribute communications signals to one or more open radio access network (O-RAN) remote units (RUs) 312 that are configured to be communicatively coupled through an O-RAN interface 314. The O-RAN RUs 312 are each configured to communicate downlink and uplink communications signals in a respective coverage cell.

The centralized services node 302 can also be interfaced with a distributed communications system (DCS) 315 through an x2 interface 316. Specifically, the centralized services node 302 can be interfaced with a digital baseband unit (BBU) 318 that can provide a digital signal source to the centralized services node 302. The digital BBU 318 may be configured to provide a signal source to the centralized services node 302 to provide downlink communications signals 320D to a digital routing unit (DRU) 322 as part of a digital distributed antenna system (DAS). The DRU 322 is configured to split and distribute the downlink communications signals 320D to different types of remote units, including a low-power remote unit (LPR) 324, a radio antenna unit (dRAU) 326, a mid-power remote unit (dMRU) 328, and a high-power remote unit (dHRU) 330. The DRU 322 is also configured to combine uplink communications signals 320U received from the LPR 324, the dRAU 326, the dMRU 328, and the dHRU 330 and provide the combined uplink communications signals to the digital BBU 318. The digital BBU 318 is also configured to interface with a third-party central unit 332 and/or an analog source 334 through a radio frequency (RF)/digital converter 336.

The DRU 322 may be coupled to the LPR 324, the dRAU 326, the dMRU 328, and the dHRU 330 via an optical fiber-based communications medium 338. In this regard, the DRU 322 can include a respective electrical-to-optical (E/O) converter 340 and a respective optical-to-electrical (O/E) converter 342. Likewise, each of the LPR 324, the dRAU 326, the dMRU 328, and the dHRU 330 can include a respective E/O converter 344 and a respective O/E converter 346.

The E/O converter 340 at the DRU 322 is configured to convert the downlink communications signals 320D into downlink optical communications signals 348D for distribution to the LPR 324, the dRAU 326, the dMRU 328, and the dHRU 330 via the optical fiber-based communications medium 338. The O/E converter 346 at each of the LPR 324, the dRAU 326, the dMRU 328, and the dHRU 330 is configured to convert the downlink optical communications signals 348D back to the downlink communications signals 320D. The E/O converter 344 at each of the LPR 324, the dRAU 326, the dMRU 328, and the dHRU 330 is configured to convert the uplink communications signals 320U into uplink optical communications signals 348U. The O/E converter 342 at the DRU 322 is configured to convert the uplink optical communications signals 348U back to the uplink communications signals 320U.

In context of the present disclosure, a wireless transmitter refers generally to a wireless communication circuit including at least a processing circuit, a memory circuit, and an antenna circuit, and can be configured to process and transmit a wireless communications signal. In this regard, the radio node 304, the O-RAN RN 312, the LPR 324, the dRAU 326, the dMRU 328, and the dHRU 330 can each function as the wireless transmitters 202 in the large venue 200 of FIG. 2.

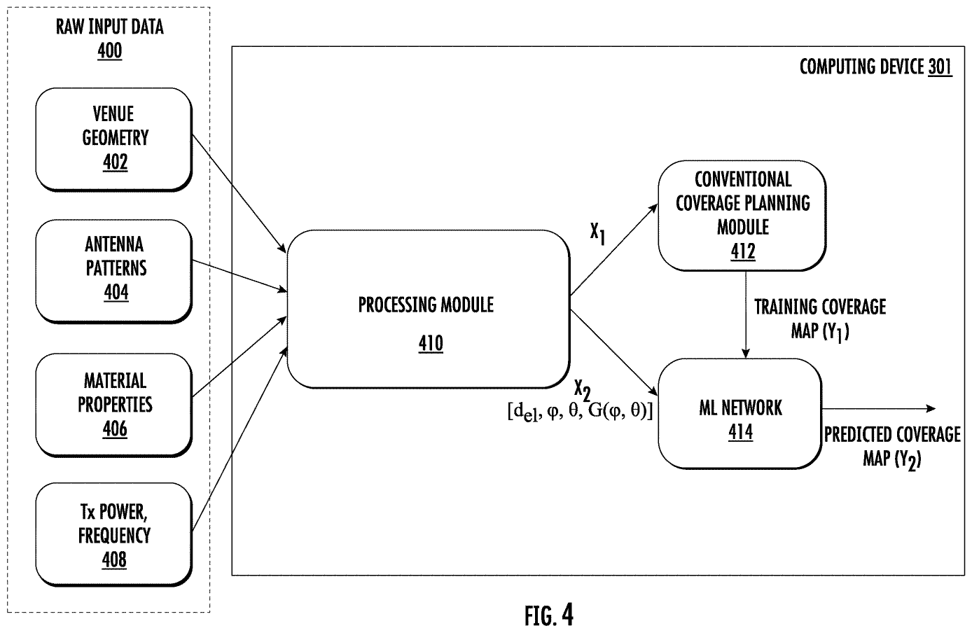

FIG. 4 is a schematic diagram providing an exemplary illustration as to how the computing device 301 can perform machine learning assisted coverage planning for the WCS 300 of FIG. 3 in the large venue 200 of FIG. 2. Common elements between FIGS. 2, 3, and 4 are shown therein with common element numbers and will not be re-described herein.

Herein, the computing device 301 is fed with a set of raw input data 400. In an embodiment, the set of raw input data 400 can include a first data set 402 containing geometry data of the large venue 200, a second data set 404 describing antenna patterns of each of the wireless transmitters 202, a third data set 406 describing transmission loss and/or reflection loss properties of materials used in the large venue 200, and a fourth data set 408 describing transmission power and transmission frequency of each of the wireless transmitters 202.

The set of raw input data 400 is received by a processing module 410. In one aspect, the processing module 410 formats the set of raw input data 400 into a set of formatted data X₁ and provides the set of formatted data X₁ to a conventional coverage planning module 412. In a non-limiting example, the conventional coverage planning module 412 can be a Ray Tracing module or a Ray Launching module. Accordingly, the set of formatted data X₁ is in a format required by the Ray Tracing or the Ray Launching module. The conventional coverage planning module 412, in turn, generates a training coverage map Y₁ for the large venue 200 based on the set of formatted data X₁.

In another aspect, the processing module 410 concurrently determines a set of refined input data X₂ from the set of raw input data 400. In an embodiment, the set of refined input data X₂ includes a relative electrical distance dₑₗ (e.g., physical distance/wavelength) between each of the wireless transmitters 202 and each of the wireless receivers 204₁-204_{N}, a relative azimuth angle φ between each of the wireless transmitters 202 and each of the wireless receivers 204₁-204_{N}, a relative elevation angle θ between each of the wireless transmitters 202 and each of the wireless receivers 204₁-204_{N}, and a relative antenna gain G(φ, θ) associated with the relative azimuth angle φ and the relative elevation angle θ between each of the wireless transmitters 202 and each of the wireless receivers 204₁-204_{N}. The processing module 410 then feeds the set of refined input data X₂ to a machine learning (ML) network 414, which can be an artificial neural network (ANN) based machine learning module or a non-ANN based machine learning module. Herein, training coverage map Y₁ and the set of refined input data X₂ are used to collectively train the ML network 414.

Notably, since the training coverage map Y₁ and the set of refined input data X₂ are both related to all the wireless transmitters 202 in the large venue 200, a training performed on the ML network 414 can still be quite time consuming and resource hungry. As such, it is desirable to further reduce the amount of data in the set of refined input data X₂ to help speed up training of the ML network 414. In this regard, the computing device 301 is further configured to sample the set of refined input data X₂ to thereby generate a significantly smaller set of training data to be used in conjunction with the training coverage map Y₁, to train the ML network 414.

In an embodiment, the computing device 301 first determines a handful of representative wireless transmitters among the wireless transmitters 202. Subsequently, the computing device 301 generates the set of training data to only include the relative electrical distance dₑₗ between each of the representative wireless transmitters and each of the wireless receivers 204, the relative azimuth angle φ between each of the representative wireless transmitters and each of the wireless receivers 204, the relative elevation angle θ between each of the representative wireless transmitters and each of the wireless receivers 204, and the relative antenna gain G(φ, θ) associated with the relative azimuth angle φ and the relative elevation angle θ between each of the representative wireless transmitters and each of the wireless receivers 204. In an embodiment, the computing device 301 can determine the representative wireless transmitters and the corresponding set of training data based on a multi-step process, which is further described below.

The computing device 301 first determines a subset of the wireless transmitters 202 deployed in the large venue 200. In an embodiment, hundreds of the wireless transmitters 202 may be deployed at the large venue 200 and the subset will include no more than M (M≤50) of the hundreds of the wireless transmitters 202. For each of the wireless transmitters 202 in the subset (hereinafter denoted as 202ᵢ for distinction, 1≤i≤M), the computing device 301 will generate a pair of azimuth and elevation angles (φ_{i,k}, θ_{i,k}) relative to each of the wireless receivers 204₁-204_{N} (1≤k≤N) that are placed in the large venue 200 according to the uniform distribution.

The computing device 301 then computes a mean azimuth value φᵢ and a standard azimuth deviation σᵢ^{φ} for each of the wireless transmitters 202i in the subset in accordance with equations (Eq. 1 and 2) below.

$${ϕ}_{i} = \frac{1}{N} {\sum }_{k = 1}^{N} {ϕ}_{i , k} \qquad ( Eq . 1 )$$

$${σ}_{i}^{θ} = \sqrt{\frac{1}{N} {\sum }_{k = 1}^{N} {( {ϕ}_{i , k -} {ϕ}_{i} )}^{2}} \qquad ( Eq . 2 )$$

The computing device 301 also computes a mean elevation value θᵢ and a standard elevation deviation σᵢ^{θ} for each of the wireless transmitters 202ᵢ in the subset in accordance with equations (Eq. 3 and 4) below.

$${θ}_{i} = \frac{1}{N} {\sum }_{k = 1}^{N} {θ}_{i , k} \qquad ( Eq . 3 )$$

$${σ}_{i}^{θ} = \sqrt{\frac{1}{N} {\sum }_{k = 1}^{N} {( {θ}_{i , k} - {\overline{θ}}_{i} )}^{2}} \qquad ( Eq . 4 )$$

The computing device 301 then computes a mean azimuth value φ and a standard azimuth deviation σ^{φ} for all the wireless transmitters 202i (1≤i≤M) in the subset in accordance with equations (Eq. 5 and 6) below.

$$ϕ = \frac{1}{M} {\sum }_{k = 1}^{M} {ϕ}_{i} \qquad ( Eq . 5 )$$

$${σ}^{ϕ} = \sqrt{\frac{1}{N * M} * {\sum }_{i = 1}^{M} {\sum }_{k = 1}^{N} {( {ϕ}_{i , k} - ϕ )}^{2}} \qquad ( Eq . 6 )$$

The computing device 301 then computes a mean elevation value θ and a standard elevation deviation σ^{θ} for all the wireless transmitters 202i (1≤i≤M) in the subset in accordance with equations (Eq. 7 and 8) below.

$$θ = \frac{1}{M} {\sum }_{k = 1}^{M} {θ}_{i} \qquad ( Eq . 7 )$$

$${σ}^{θ} = \sqrt{\frac{1}{N * M} {\sum }_{i = 1}^{M} {\sum }_{k = 1}^{N} {( {θ}_{i , k -} θ )}^{2}} \qquad ( Eq . 8 )$$

The mean values and the standard deviations as in the equations (Eq. 1-8) can be rapidly computed based on receiver and transmitter coordinates in the large venue 200. It does not require real time simulations. For each of the wireless transmitters 202i in the subset (1≤i≤M), the computing device 301 further computes an azimuth z-score zᵢ^{φ}, an elevation z-score zᵢ^{θ}, and a total z-score zᵢ according to equations (Eq. 9, 10, and 11) below.

$${z}_{i}^{ϕ} = \frac{{ϕ}_{i} - ϕ}{\sqrt{\frac{{( {σ}_{i}^{ϕ} )}^{2}}{N} + \frac{{( {σ}_{ϕ} )}^{2}}{N * M}}} \qquad ( Eq . 9 )$$

$${z}_{i}^{θ} = \frac{{θ}_{i} - θ}{\sqrt{\frac{{( {σ}_{i}^{θ} )}^{2}}{N} + \frac{{( {σ}_{θ} )}^{2}}{N * M}}} \qquad ( Eq . 10 )$$

$${z}_{i} = ( {z}_{i}^{ϕ} + {z}_{i}^{θ} ) / 2 \qquad ( Eq . 11 )$$

Notably, an azimuth z-score zᵢ^{φ} that is close to zero shows that the training based on the subset of wireless transmitters 202ᵢ (1≤i≤M) and testing distributions with respect to all the wireless transmitters 202 in the large venue 200 for the azimuth angle are close to each other. In contrast, a larger azimuth z-score zᵢ^{φ} can correspond to a “distant” distribution in the feature space. Similarly, an elevation z-score zᵢ^{θ} that is close to zero shows that the training based on the subset of wireless transmitters 202ᵢ (1≤i≤M) and testing distributions with respect to all the wireless transmitters 202 in the large venue 200 for the elevation angle are close to each other. In contrast, a larger elevation z-score zᵢ^{θ} can correspond to a “distant” distribution in the feature space.

According to an embodiment of the present disclosure, the computing device 301 is further configured to select three of the wireless transmitters 202i (1≤i≤M) to be the representative wireless transmitters for training the ML network 414. Specifically, the computing device 301 selects a first one of the three representative wireless transmitters as the one with a smallest total z-score zᵢ, a second one of the three representative wireless transmitters as the one with a largest positive azimuth z-score zᵢ^{φ} or a largest positive elevation z-score zᵢ^{θ}, and a third one of the three representative wireless transmitters as the one with a smallest negative azimuth z-score zᵢ^{φ} or a smallest elevation z-score zᵢ^{θ}.

Upon determining the three representative wireless transmitters, the computing device 301 can then determine the set of training data for training the ML network 414 based on the determined three representative wireless transmitters. Specifically, the set of training data includes the relative electrical distance dₑₗ between each of the first wireless transmitter, the second wireless transmitter, and the third wireless transmitter and each of the wireless receivers 204₁-204_{N}, the relative azimuth angle φ between each of the first wireless transmitter, the second wireless transmitter, and the third wireless transmitter and each of the wireless receivers 204₁-204_{N}, the relative elevation angle θ between each of the first wireless transmitter, the second wireless transmitter, and the third wireless transmitter and each of the wireless receivers 204₁-204_{N}, and the relative antenna gain G(φ, θ) associated with the relative azimuth angle and the relative elevation angle between each of the first wireless transmitter, the second wireless transmitter, and the third wireless transmitter and each of the wireless receivers 204₁-204_{N}.

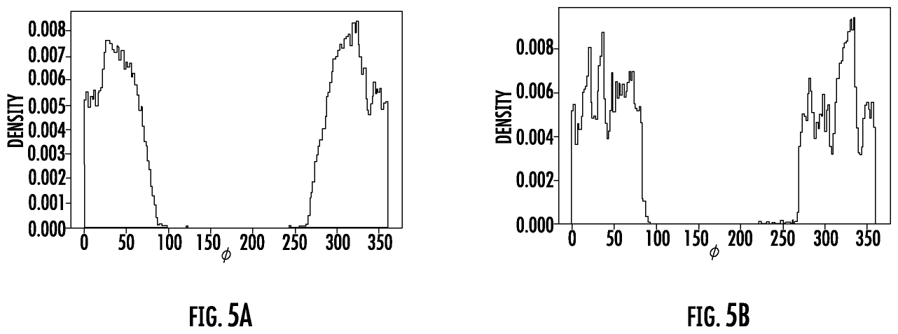

Studies have shown that training the ML network 414 based on the three representative wireless transmitters produces similar results as training the ML network 414 based on all the wireless transmitters 202i (1≤i≤M). FIGS. 5A and 5B are histograms providing an exemplary visual validation of the trainings performed on the ML network 414 in FIG. 4. Specifically, FIG. 5A illustrates a testing distribution of the azimuth angle (P when all the wireless transmitters 202i (1≤i≤M) are used to train the ML network 414 and FIG. 5B illustrates a testing distribution of the azimuth angle φ when the three representative wireless transmitters are used to train the ML network 414. The histograms shown in FIGS. 5A and 5B indicate that training the ML network 414 based on the three representative wireless transmitters produces similar results as training the ML network 414 based on all the wireless transmitters 202i (1≤i≤M). Thus, by training the ML network 414 based on the substantially smaller set of training data that corresponds to the three representative wireless transmitters, it is possible to train the ML network 414 accurately with lesser time and computing resources.

With reference back to FIG. 4, the ML network 414 is configured to generate a predicted coverage map Y₂ and the computing device 301 is further configured to perform a mean absolute error (MAE) test to validate the predicted coverage map Y₂ based on the training coverage map Y₁.

$$MAE = \frac{1}{N} {\sum }_{i = 1}^{N} \vert {RSS}_{i , Y 2} ( dB ) - {RSS}_{i , Y 1} ( dB ) \vert \qquad ( Eq . 12 )$$

According to equation (Eq. 12), the ML network 414 is considered well trained when the MAE is below 3 dB. Once the ML network 414 is well trained, the computing device 301 can execute the trained ML network 414 to predict a future coverage map in response to a configuration change (e.g., adding, removing, relocating any of the wireless transmitters 202) in the large venue 200.

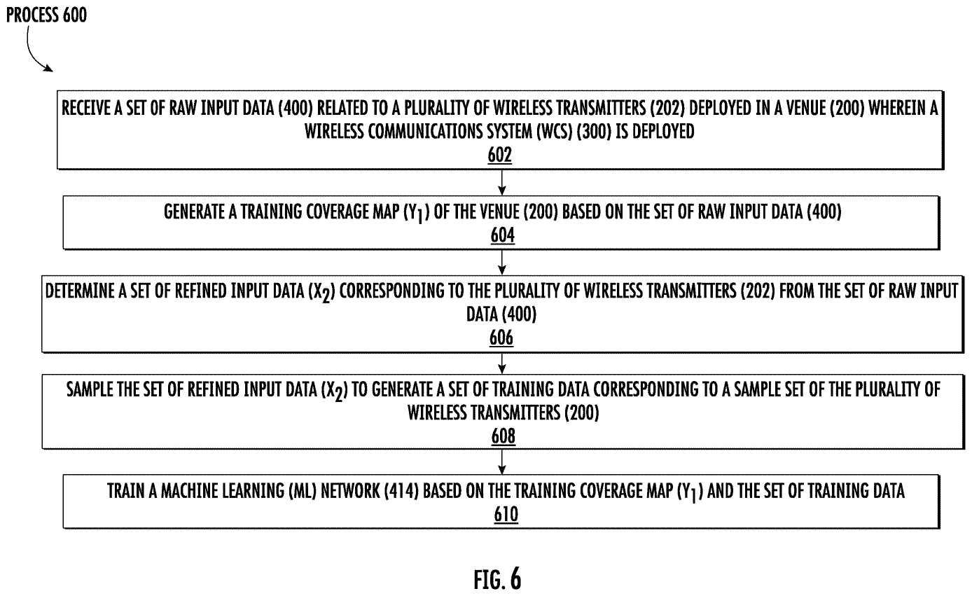

The computing device 301 can be configured to perform machine learning assisted coverage planning based on a process. In this regard, FIG. 6 is a flowchart of an exemplary process 600 that can be employed by the computing device 301 in FIG. 4 for performing machine learning assisted coverage planning for the WCS 300 of FIG. 3.

Herein, the computing device 301 receives the set of raw input data 400 related to the wireless transmitters 202 deployed in the large venue 200 wherein the WCS 300 is deployed (block 602). The computing device 301 then generates the training coverage map Y₁ of the large venue 200 based on the set of raw input data 400 (block 604). Next, the computing device 301 determines the set of refined input data X₂ corresponding to the wireless transmitters 202 from the set of raw input data 400 (block 606). Next, the computing device 301 samples the set of refined input data X₂ to generate the set of training data corresponding to the sample set (a.k.a. the representative wireless transmitters) of the wireless transmitters 202 (block 608). The computing device 301 then trains the ML network 414 based on the training coverage map Y₁ and the set of training data (block 610).

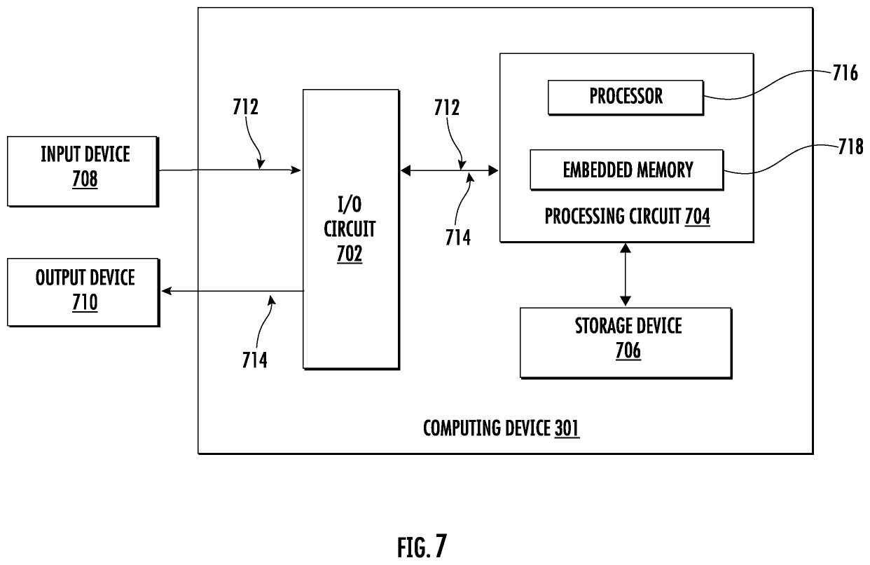

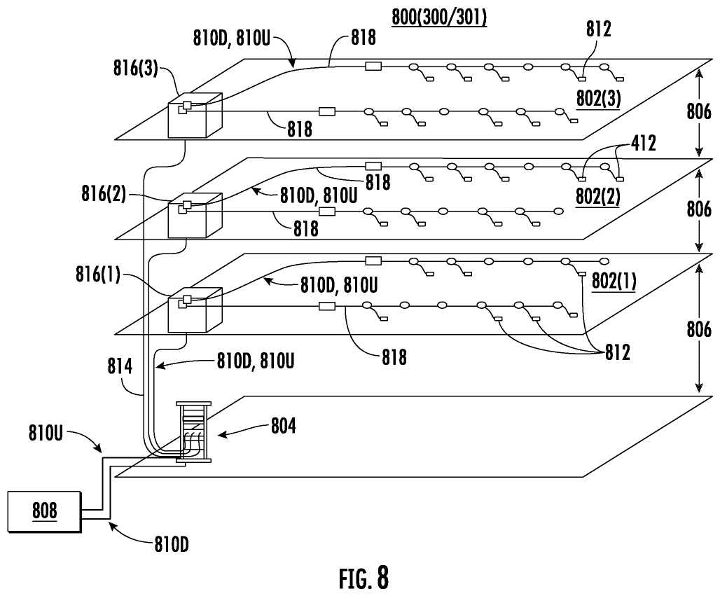

FIG. 7 is a schematic diagram providing an exemplary illustration of the computing device 301 of FIG. 4. Common elements between FIGS. 4 and 7 are shown therein with common element numbers and will not be re-described herein.

In an embodiment, the computing device 301 includes an input/output (I/O) circuit 702, a processing circuit 704, and a storage device 706. The I/O circuit 702 may include or be communicatively coupled to an input device 708 and an output device 710. The input device 708 may be a computer keyboard, a scanner, a media reader, and so on. The output device 710 may be a computer monitor, a printer, a portable or cloud-based storage device, and so on. According to an embodiment of the present disclosure, the input device 708 is configured to provide the set of raw input data 400 to the I/O circuit 702, while the output device 710 is configured to output the predicted coverage map Y₂ generated by the processing circuit 704.

The processing circuit 704, which can be a field-programmable gate array (FPGA) or an application-specific integrated circuit (ASIC), as an example, includes at least one processor 716 (e.g., a microprocessor) and an embedded memory 718 (e.g., a flash memory). In a non-limiting example, the embedded memory 718 can store computer instructions to program the processor 716 to implement the ML network 414 and carry out machine learning assisted coverage planning. The embedded memory 718 may also store the set of raw input data 400, the set of refined input data X₂, the training coverage map Y₁, the set of training data for training the ML network 414, coordinates of the wireless transmitters 202, and any intermediate processing data.

With reference back to FIG. 4, the ML network 414 as trained based on embodiments disclosed herein generalizes well to any RF frequencies. This is because of the choice of the input feature of the electrical distance. For new patterns and geometries, the z-score of the training and testing distributions of azimuth and elevation angles and patterns shows whether additional training is needed or not. Even if additional training is needed (e.g., new triplets of training antennas), the computational cost is significantly smaller compared to running real time analysis for tens to hundreds of wireless transmitters.

The WCS 300 of FIG. 3, which can include the computing device 301 in FIG. 4, can be provided in an indoor environment as illustrated in FIG. 8. FIG. 8 is a partial schematic cut-away diagram of an exemplary building infrastructure 800 in a WCS, such as the WCS 300 of FIG. 3 that includes the computing device 301 of FIG. 4 to perform machine learning assisted coverage planning. The building infrastructure 800 in this embodiment includes a first (ground) floor 802(1), a second floor 802(2), and a third floor 802(3). The floors 802(1)-802(3) are serviced by a central unit 804 to provide antenna coverage areas 806 in the building infrastructure 800. The central unit 804 is communicatively coupled to a base station 808 to receive downlink communications signals 810D from the base station 808. The central unit 804 is communicatively coupled to a plurality of remote units 812 to distribute the downlink communications signals 810D to the remote units 812 and to receive uplink communications signals 810U from the remote units 812, as previously discussed above. The downlink communications signals 810D and the uplink communications signals 810U communicated between the central unit 804 and the remote units 812 are carried over a riser cable 814. The riser cable 814 may be routed through interconnect units (ICUs) 816(1)-816(3) dedicated to each of the floors 802(1)-802(3) that route the downlink communications signals 810D and the uplink communications signals 810U to the remote units 812 and also provide power to the remote units 812 via array cables 818.

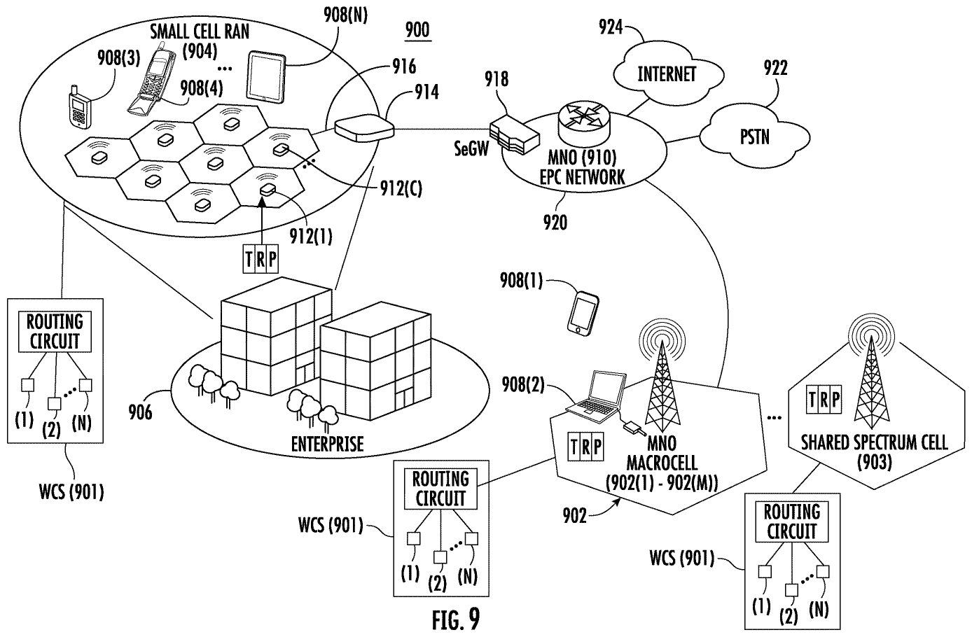

The WCS 300 of FIG. 3 and the computing device 301 of FIG. 4, configured to perform machine learning assisted coverage planning, can also be interfaced with different types of radio nodes of service providers and/or supporting service providers, including macrocell systems, small cell systems, and remote radio heads (RRH) systems, as examples. For example, FIG. 9 is a schematic diagram of an exemplary mobile telecommunications environment 900 (also referred to as “environment 900”) that includes radio nodes and cells that may support shared spectrum, such as unlicensed spectrum, and can be interfaced to shared spectrum WCSs 901 supporting coordination of distribution of shared spectrum from multiple service providers to remote units to be distributed to subscriber devices. The shared spectrum WCSs 901 can include the WCS 300 of FIG. 3 that includes the computing device 301 of FIG. 4, as an example.

The environment 900 includes exemplary macrocell RANs 902(1)-902(M) (“macrocells 902(1)-902(M)”) and an exemplary small cell RAN 904 located within an enterprise environment 906 and configured to service mobile communications between a user mobile communications device 908(1)-908(N) to a mobile network operator (MNO) 910. A serving RAN for the user mobile communications devices 908(1)-908(N) is a RAN or cell in the RAN in which the user mobile communications devices 908(1)-908(N) have an established communications session with the exchange of mobile communications signals for mobile communications. Thus, a serving RAN may also be referred to herein as a serving cell. For example, the user mobile communications devices 908(3)-908(N) in FIG. 9 are being serviced by the small cell RAN 904, whereas the user mobile communications devices 908(1) and 908(2) are being serviced by the macrocell 902. The macrocell 902 is an MNO macrocell in this example. However, a shared spectrum RAN 903 (also referred to as “shared spectrum cell 903”) includes a macrocell in this example and supports communications on frequencies that are not solely licensed to a particular MNO, such as CBRS for example, and thus may service user mobile communications devices 908(1)-908(N) independent of a particular MNO. For example, the shared spectrum cell 903 may be operated by a third party that is not an MNO and wherein the shared spectrum cell 903 supports CBRS. Also, as shown in FIG. 9, the MNO macrocell 902, the shared spectrum cell 903, and/or the small cell RAN 904 can interface with a shared spectrum WCS 901 supporting coordination of distribution of shared spectrum from multiple service providers to remote units to be distributed to subscriber devices. The MNO macrocell 902, the shared spectrum cell 903, and the small cell RAN 904 may be neighboring radio access systems to each other, meaning that some or all can be in proximity to each other such that a user mobile communications device 908(3)-908(N) may be able to be in communications range of two or more of the MNO macrocell 902, the shared spectrum cell 903, and the small cell RAN 904 depending on the location of the user mobile communications devices 908(3)-908(N).

In FIG. 9, the mobile telecommunications environment 900 in this example is arranged as an LTE system as described by the Third Generation Partnership Project (3GPP) as an evolution of the GSM/UMTS standards (Global System for Mobile communication/Universal Mobile Telecommunications System). It is emphasized, however, that the aspects described herein may also be applicable to other network types and protocols. The mobile telecommunications environment 900 includes the enterprise environment 906 in which the small cell RAN 904 is implemented. The small cell RAN 904 includes a plurality of small cell radio nodes 912(1)-912(C). Each small cell radio node 912(1)-912(C) has a radio coverage area (graphically depicted in the drawings as a hexagonal shape) that is commonly termed a “small cell.” A small cell may also be referred to as a femtocell or, using terminology defined by 3GPP, as a Home Evolved Node B (HeNB). In the description that follows, the term “cell” typically means the combination of a radio node and its radio coverage area unless otherwise indicated.

In FIG. 9, the small cell RAN 904 includes one or more services nodes (represented as a single services node 914) that manage and control the small cell radio nodes 912(1)-912(C). In alternative implementations, the management and control functionality may be incorporated into a radio node, distributed among nodes, or implemented remotely (i.e., using infrastructure external to the small cell RAN 904). The small cell radio nodes 912(1)-912(C) are coupled to the services node 914 over a direct or local area network (LAN) connection 916 as an example, typically using secure IPsec tunnels. The small cell radio nodes 912(1)-912(C) can include multi-operator radio nodes. The services node 914 aggregates voice and data traffic from the small cell radio nodes 912(1)-912(C) and provides connectivity over an IPsec tunnel to a security gateway (SeGW) 918 in a network 920 (e.g., evolved packet core (EPC) network in a 4G network, or 5G Core in a 5G network) of the MNO 910. The network 920 is typically configured to communicate with a public switched telephone network (PSTN) 922 to carry circuit-switched traffic, as well as for communicating with an external packet-switched network such as the Internet 924.

The environment 900 also generally includes a node (e.g., eNodeB or gNodeB) base station, or “macrocell” 902. The radio coverage area of the macrocell 902 is typically much larger than that of a small cell where the extent of coverage often depends on the base station configuration and surrounding geography. Thus, a given user mobile communications device 908(3)-908(N) may achieve connectivity to the network 920 (e.g., EPC network in a 4G network, or 5G Core in a 5G network) through either a macrocell 902 or small cell radio node 912(1)-912(C) in the small cell RAN 904 in the environment 900.

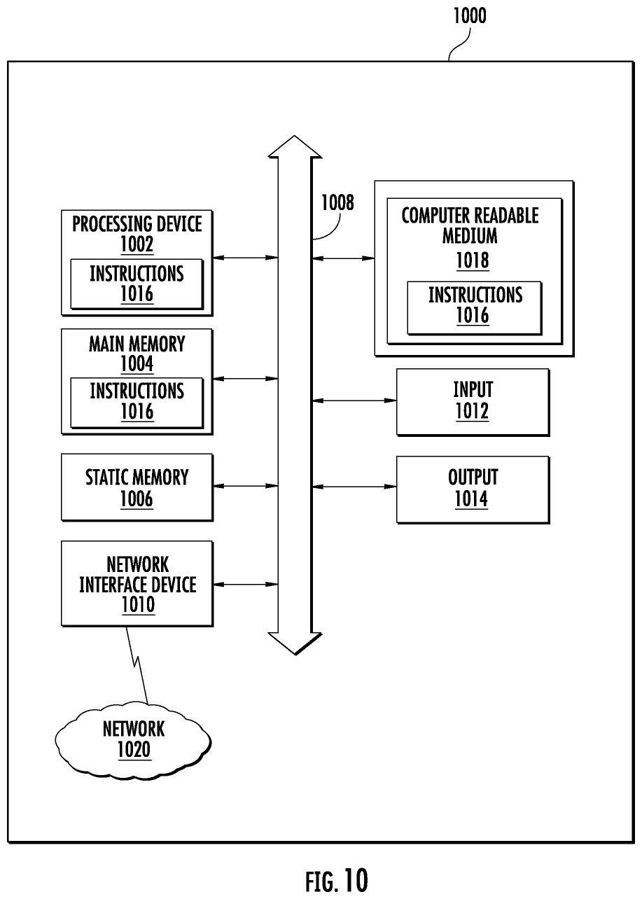

Any of the circuits in the WCS 300 of FIG. 3 and the computing device 301 of FIGS. 4 and 7, such as the processing circuit 704, can include a computer system 1000, such as that shown in FIG. 10, to carry out their functions and operations. With reference to FIG. 10, the computer system 1000 includes a set of instructions for causing the multi-operator radio node component(s) to provide its designed functionality, and the circuits discussed above. The multi-operator radio node component(s) may be connected (e.g., networked) to other machines in a LAN, an intranet, an extranet, or the Internet. The multi-operator radio node component(s) may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The multi-operator radio node component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server, edge computer, or a user's computer. The exemplary computer system 1000 in this embodiment includes a processing circuit or processor 1002, a main memory 1004 (e.g., read-only memory (ROM), flash memory, dynamic random access memory (DRAM) such as synchronous DRAM (SDRAM), etc.), and a static memory 1006 (e.g., flash memory, static random access memory (SRAM), etc.), which may communicate with each other via a data bus 1008. Alternatively, the processing circuit 1002 may be connected to the main memory 1004 and/or static memory 1006 directly or via some other connectivity means. The processing circuit 1002 may be a controller, and the main memory 1004 or static memory 1006 may be any type of memory.

The processing circuit 1002 represents one or more general-purpose processing circuits such as a microprocessor, central processing unit, or the like. More particularly, the processing circuit 1002 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing circuit 1002 is configured to execute processing logic in instructions 1016 for performing the operations and steps discussed herein.

The computer system 1000 may further include a network interface device 1010. The computer system 1000 also may or may not include an input 1012 to receive input and selections to be communicated to the computer system 1000 when executing instructions. The computer system 1000 also may or may not include an output 1014, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 1000 may or may not include a data storage device that includes instructions 1016 stored in a computer-readable medium 1018. The instructions 1016 may also reside, completely or at least partially, within the main memory 1004 and/or within the processing circuit 1002 during execution thereof by the computer system 1000, the main memory 1004 and the processing circuit 1002 also constituting the computer-readable medium 1018. The instructions 1016 may further be transmitted or received over a network 1020 via the network interface device 1010.

While the computer-readable medium 1018 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the processing circuit and that cause the processing circuit to perform any one or more of the methodologies of the embodiments disclosed herein. The term “computer-readable medium” shall accordingly be taken to include, but not be limited to, solid-state memories, optical and magnetic medium.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read only memory (“ROM”), random access memory (“RAM”), magnetic disk storage medium, optical storage medium, flash memory devices, etc.), and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components and/or systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented as electronic hardware, instructions stored in memory or in another computer-readable medium and executed by a processor or other processing device, or combinations of both. The various illustrative logical blocks, modules, and circuits described in connection with the embodiments disclosed herein may be implemented with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein, as examples. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

We claim:

1. A computing device configured to:
receive a set of raw input data related to a plurality of wireless transmitters deployed in a venue wherein a wireless communications system (WCS) is deployed;
generate a training coverage map of the venue based on the set of raw input data;
determine a set of refined input data corresponding to the plurality of wireless transmitters from the set of raw input data;
sample the set of refined input data to generate a set of training data corresponding to a sample set of the plurality of wireless transmitters; and
train a machine learning (ML) network based on the training coverage map and the set of training data.

2. The computing device of claim 1, further configured to perform a mean absolute error (MAE) test based on the training coverage map to validate the trained ML network.

3. The computing device of claim 1, further configured to execute the trained ML network to predict a future coverage map in response to a configuration change in the venue.

4. The computing device of claim 1, wherein the set of raw input data comprises:
geometry data of the venue;
transmission loss and/or reflection loss properties of materials used in the venue; and
an antenna pattern, a transmission power, and a transmission frequency of each of the plurality of wireless transmitters.

5. The computing device of claim 1, further configured to:
format the set of raw input data into a set of formatted input data; and
feed the set of formatted input data to one of a Ray Tracking module and a Ray Launching module to thereby generate the training coverage map.

6. The computing device of claim 1, further configured to:
determine a distribution of a plurality of wireless receivers in the venue; and
determine the set of refined input data from the set of raw input data to comprise:
a relative electrical distance between each of the plurality of wireless transmitters and each of the plurality of wireless receivers;
a relative azimuth angle between each of the plurality of wireless transmitters and each of the plurality of wireless receivers;
a relative elevation angle between each of the plurality of wireless transmitters and each of the plurality of wireless receivers; and
a relative antenna gain associated with the relative azimuth angle and the relative elevation angle between each of the plurality of wireless transmitters and each of the plurality of wireless receivers.

7. The computing device of claim 6, further configured to determine the distribution of the plurality of wireless receivers in the venue according to a uniform distribution.

8. The computing device of claim 6, further configured to:
determine a subset of the plurality of wireless transmitters in the venue;
calculate an azimuth z-score, an elevation z-score, and a total z-score for each of the subset of the plurality of wireless transmitters based on the relative azimuth angle and the relative elevation angle between the subset of the plurality of wireless transmitters and each of the plurality of wireless receivers;
determine the sample set of the plurality of wireless transmitters among the subset of the plurality of wireless transmitters to comprise:
a first wireless transmitter among the subset of the plurality of wireless transmitters having a smallest total z-score;
a second wireless transmitter among the subset of the plurality of wireless transmitters having a largest positive azimuth z-score or a largest positive elevation z-score; and
a third wireless transmitter among the subset of the plurality of wireless transmitters having a smallest negative azimuth z-score or a smallest elevation z-score; and
determine the set of training data to comprise:
the relative electrical distance between each of the first wireless transmitter, the second wireless transmitter, and the third wireless transmitter and each of the plurality of wireless receivers;
the relative azimuth angle between each of the first wireless transmitter, the second wireless transmitter, and the third wireless transmitter and each of the plurality of wireless receivers;
the relative elevation angle between each of the first wireless transmitter, the second wireless transmitter, and the third wireless transmitter and each of the plurality of wireless receivers; and
the relative antenna gain associated with the relative azimuth angle and the relative elevation angle between each of the first wireless transmitter, the second wireless transmitter, and the third wireless transmitter and each of the plurality of wireless receivers.

9. A method for using machine learning (ML) to assist in coverage planning of a wireless communications system (WCS), comprising:
receiving a set of raw input data related to a plurality of wireless transmitters deployed in a venue wherein the WCS is deployed;
generating a training coverage map of the venue based on the set of raw input data;
determining a set of refined input data corresponding to the plurality of wireless transmitters from the set of raw input data;
sampling the set of refined input data to generate a set of training data corresponding to a sample set of the plurality of wireless transmitters; and
training an ML network based on the training coverage map and the set of training data.

10. The method of claim 9, further comprising performing a mean absolute error (MAE) test based on the training coverage map to validate the trained ML network.

11. The method of claim 9, further comprising executing the trained ML network to predict a future coverage map in response to a configuration change in the venue.

12. The method of claim 9, further comprising receiving the set of raw input data that comprises:
geometry data of the venue;
transmission loss and/or reflection loss properties of materials used in the venue; and
an antenna pattern, a transmission power, and a transmission frequency of each of the plurality of wireless transmitters.

13. The method of claim 9, further comprising:
formatting the set of raw input data into a set of formatted input data; and
feeding the set of formatted input data to one of a Ray Tracking module and a Ray Launching module to thereby generate the training coverage map.

14. The method of claim 9, further comprising:
determining a distribution of a plurality of wireless receivers in the venue; and
determining the set of refined input data from the set of raw input data to comprise:
a relative electrical distance between each of the plurality of wireless transmitters and each of the plurality of wireless receivers;
a relative azimuth angle between each of the plurality of wireless transmitters and each of the plurality of wireless receivers;
a relative elevation angle between each of the plurality of wireless transmitters and each of the plurality of wireless receivers; and
a relative antenna gain associated with the relative azimuth angle and the relative elevation angle between each of the plurality of wireless transmitters and each of the plurality of wireless receivers.

15. The method of claim 14, further comprising determining the distribution of the plurality of wireless receivers in the venue according to a uniform distribution.

16. The method of claim 14, further comprising:
determining a subset of the plurality of wireless transmitters in the venue;
calculating an azimuth z-score, an elevation z-score, and a total z-score for each of the subset of the plurality of wireless transmitters based on the relative azimuth angle and the relative elevation angle between the subset of the plurality of wireless transmitters and each of the plurality of wireless receivers;
determining the sample set of the plurality of wireless transmitters among the subset of the plurality of wireless transmitters to comprise:
a first wireless transmitter among the subset of the plurality of wireless transmitters having a smallest total z-score;
a second wireless transmitter among the subset of the plurality of wireless transmitters having a largest positive azimuth z-score or a largest positive elevation z-score; and
a third wireless transmitter among the subset of the plurality of wireless transmitters having a smallest negative azimuth z-score or a smallest elevation z-score; and
determining the set of training data to comprise:
the relative electrical distance between each of the first wireless transmitter, the second wireless transmitter, and the third wireless transmitter and each of the plurality of wireless receivers;
the relative azimuth angle between each of the first wireless transmitter, the second wireless transmitter, and the third wireless transmitter and each of the plurality of wireless receivers;
the relative elevation angle between each of the first wireless transmitter, the second wireless transmitter, and the third wireless transmitter and each of the plurality of wireless receivers; and
the relative antenna gain associated with the relative azimuth angle and the relative elevation angle between each of the first wireless transmitter, the second wireless transmitter, and the third wireless transmitter and each of the plurality of wireless receivers.

17. A wireless communications system (WCS), comprising:
a centralized services node coupled to a service node;
a plurality of wireless transmitters coupled to the centralized services node; and
a computing device configured to:
receive a set of raw input data related to the plurality of wireless transmitters deployed in a venue wherein the WCS is deployed;
generate a training coverage map of the venue based on the set of raw input data;
determine a set of refined input data corresponding to the plurality of wireless transmitters from the set of raw input data;
sample the set of refined input data to generate a set of training data corresponding to a sample set of the plurality of wireless transmitters; and
train a machine learning (ML) network based on the training coverage map and the set of training data.

18. The WCS of claim 17, wherein the computing device is further configured to execute the trained ML network to predict a future coverage map in response to a configuration change in the venue.

19. The WCS of claim 17, wherein the centralized services node comprises the computing device.

20. The WCS of claim 17, further comprising a routing unit (RU) coupled to a plurality of remote units via a plurality of optical fiber-based communications mediums.
